(19) United States
(12) Patent Application Publication
(10) Pub. No.: US 2014/0198196 A1
(43) Pub. Date: Jul. 17, 2014

(54) System And Method For Determining Engagement Of Audience Members During A Lecture

(71) Applicant: Massively Parallel Technologies, Inc., Boulder, CO (US)

(72) Inventors: Kevin D. Howard, Tempe, AZ (US); Prasanna Shreenivas Sattigeri, Tempe, AZ (US)

(73) Assignee: Massively Parallel Technologies, Inc., Boulder, CO (US)

(21) Appl. No.: 14/155,316

(22) Filed: Jan. 14, 2014

Related U.S. Application Data
(60) Provisional application No. 61/752,120, filed on Jan. 14, 2013.

(51) Int. Cl. G06K 9/00

(52) U.S. Cl. CPC G06K 9/00281
USPC 348/78

(57) ABSTRACT

A system and method for determining engagement of members of an audience during a lecture. Speech by the lecturer is detected to initiate image processing, which is performed by first capturing the audience in multiple image frames using a video camera; performing edge detection on an image frame to generate a digital edge map of the frame; detecting an approximate facial region skeletal image candidate in the image frame including circular and elliptical shapes for iris, eye and face; extracting location information for a candidate face in the image frame, including eyes and irises in the skeletal image to generate approximate facial region location information; and determining, from the location information, whether required spatial relationships exist within a candidate, for that candidate to be considered as a face of one of the members. When an iris is essentially circular, the member with a corresponding face is considered to be engaged.

### RELATED APPLICATIONS

This application claims priority to U.S. Provisional Application Ser. No. 61/752,120, filed Jan. 14, 2013, and entitled “System and Method for Determining Engagement of Audience Members During A Lecture”, and which is incorporated by reference in its entirety herewith.

### BACKGROUND

### Problem to be Solved

Humans have given informational lectures for thousands of years. Since the purpose of a lecture is to impart information, it is desirable to ensure that the maximum amount of information be transmitted during the course of the lecture. An important initial step in being able to effectively transmit information to an audience is to insure that the audience is engaged.

### SUMMARY

### Solution

When an audience is generally engaged with the lecturer, a high percentage of the members of the audience are looking directly at the lecturer. Therefore, it is desirable to be able to determine the percentage of an audience that is facing a lecturer to determine the relative amount of audience engagement.

Audience engagement with a lecturer can be detected as a function of the percentage of the audience watching the lecturer when the lecturer is speaking.

The present system detects audience engagement with a lecturer by determining the location of human faces and eyes from an image taken by a camera. If the irises of the eyes in the image of a particular face are circular or nearly circular, then those eyes are looking directly at the camera. The more elliptical the apparent shape of the iris in the camera image, the less the eye is looking in the direction of the camera. An audience member who is looking essentially directly at a lecturer during a lecture is considered to be engaged.

This observation can be used to perform activities including real-time notification to the lecturer when the audience is not engaged, lecturer training, continuous lecturer assessment, lecturer comparison, and video and non-video conference/classroom assessment.

### BRIEF DESCRIPTION OF THE DRAWINGS

FIG. 1A is a diagram showing an exemplary system for determining engagement of audience members during a lecture;

FIG. 2A is an example showing positions of eyes and irises in a facial image of an audience member looking directly at a camera;

FIG. 2B is an example showing eye position and iris shape on a face looking away from the camera;

FIG. 2C is an example of an image frame showing multiple facial image candidates;

FIG. 2D is an example of an edge map showing multiple facial images after edge detection;

FIG. 3 is a flowchart showing an exemplary set of steps performed in one embodiment of the present method;

FIG. 4 is a diagram showing an exemplary candidate image obtained after edge detection;

FIG. 5A is a diagram showing circles and ellipses comprising candidate approximate facial region (AFR) images in an exemplary AFR edge map;

FIG. 5B is a diagram showing a candidate AFR image comprising an exemplary detected ellipse corresponding to an AFR; and

FIGS. 6A, 6B, and 6C are diagrams showing exemplary camera configurations for various stage and lecturer styles.

### DETAILED DESCRIPTION

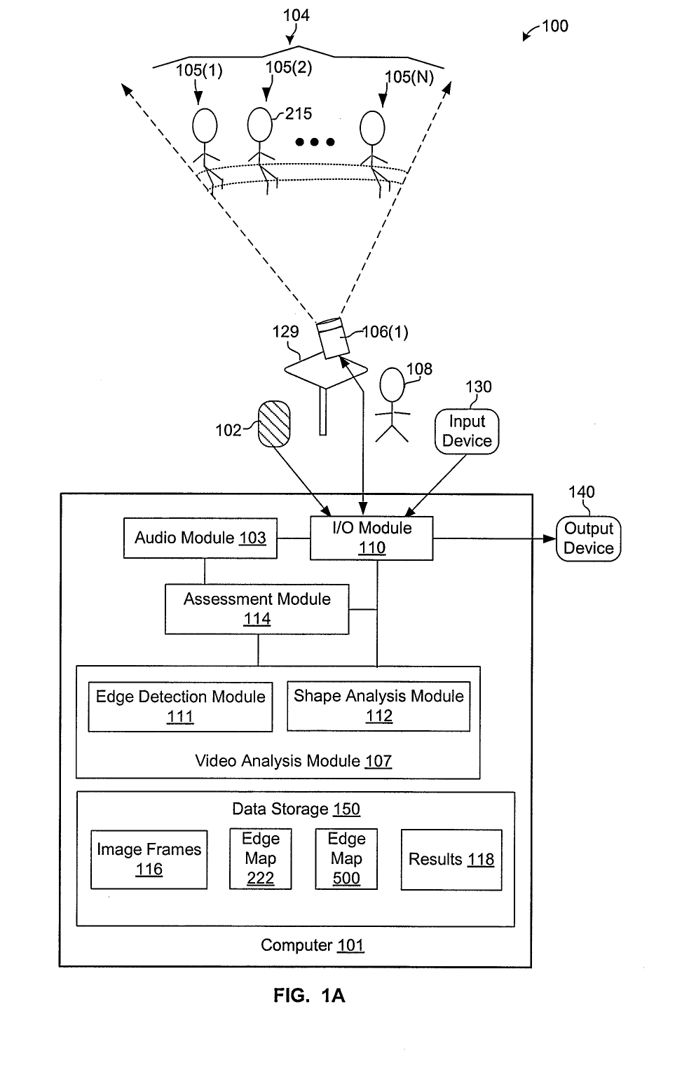

FIG. 1A is a diagram showing an exemplary system 100 for determining engagement of members 105(*) of an audience 104 during a lecture [where the symbol “*” is a ‘wild card’ operator, indicating any one member of a class of items]. As shown in FIG. 1A, in an exemplary embodiment, the present system comprises a camera 106(1), a microphone 102, a laptop or tablet computer, smart phone, or other input device 130, and an output device 140, such as a display terminal, all of which are coupled, wirelessly or via cable, to a computer 101, through I/O module 110. During system operation, computer 101 executes I/O module 110, video analysis module 107, audio module 103, and assessment module 114. In the present document, a “module” comprises an algorithm in computer-implementable form, such as a set of computer-executable instructions or firmware.

Computer 101 is also operably coupled to data storage area 150, which may comprise RAM memory, disk drive memory, and/or any other suitable form of data storage. In one embodiment, data storage area 150 contains digital image frames 116 of audience members 105(*), captured from one or more cameras 106(*), and other data, described below. Cameras 106(*) may be digital video or still-frame cameras. Unless otherwise specifically indicated as being performed by other modules or devices, system operation is controlled by assessment module 114, which is coupled to input device 120, audio module 103, and video analysis module 107, all of which are executed by computer 101, or other processors (not shown). A parallel processing environment may be desirable for executing some or all of the system modules described herein.

### Relationship Between Apparent Shape of Iris and Engagement of Audience

Using computer image processing techniques, it is possible to determine the location of human faces and eyes from an image taken by a camera. If the irises of the eyes in the image of a particular face are circular or nearly circular, then those eyes are looking directly at the camera. The more elliptical the apparent shape of the iris in the camera image, the less the eye is looking in the direction of the camera. An audience member 105 who is looking essentially directly at a lecturer 108 during a lecture is considered to be engaged.

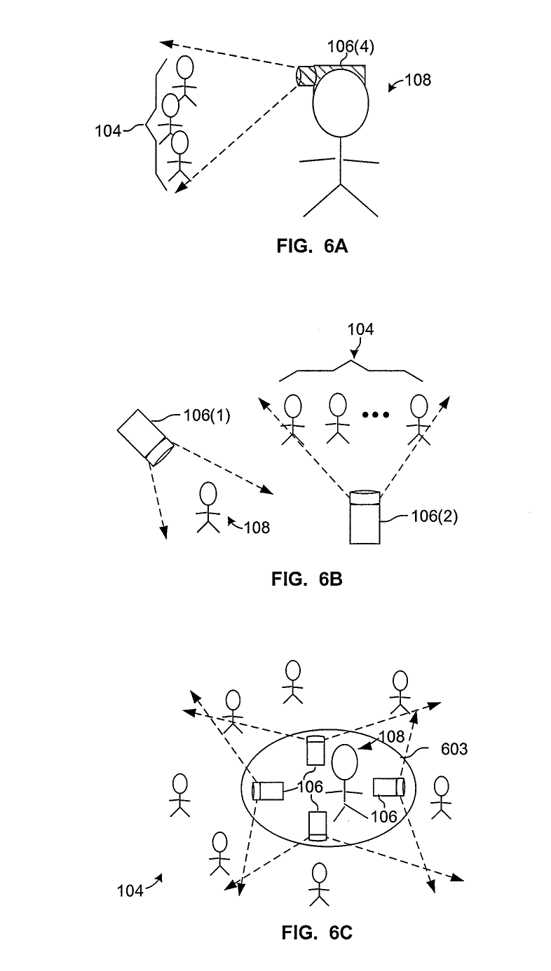

Unless a camera is mounted on the lecturer's head, however, engaged members will generally not be looking directly at a camera 106(*). Thus camera placement should be such that there is a minimum distance between a given camera 106 and the lecturer, to minimize the angle between the camera and lecturer as seen by a given observer in the audience, and accordingly minimize anomalous eccentricity of iris images. Other camera placement options are described below with respect to FIG. 6.

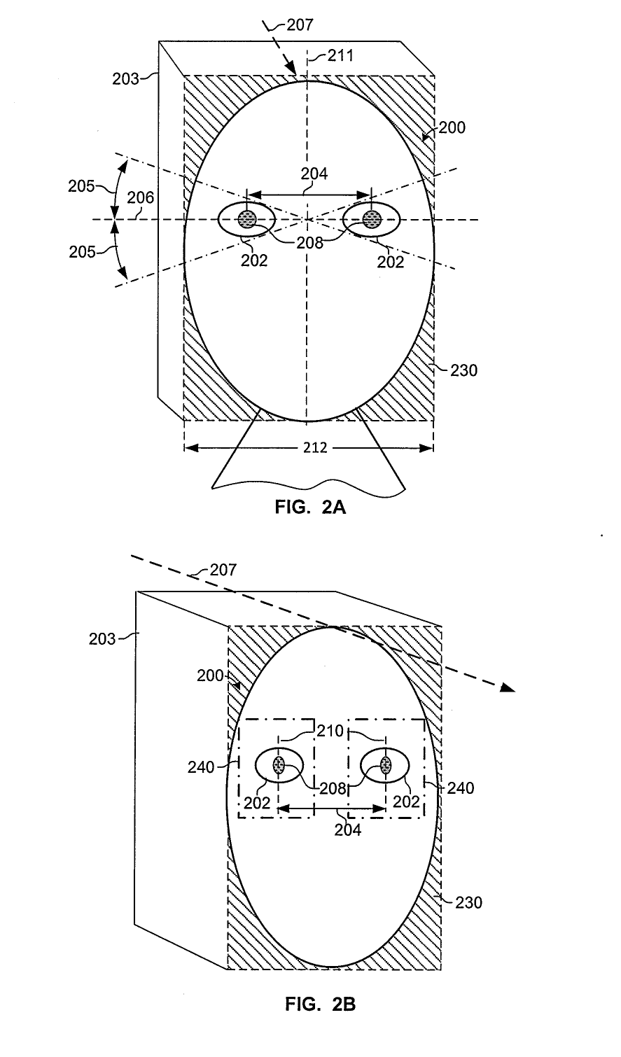

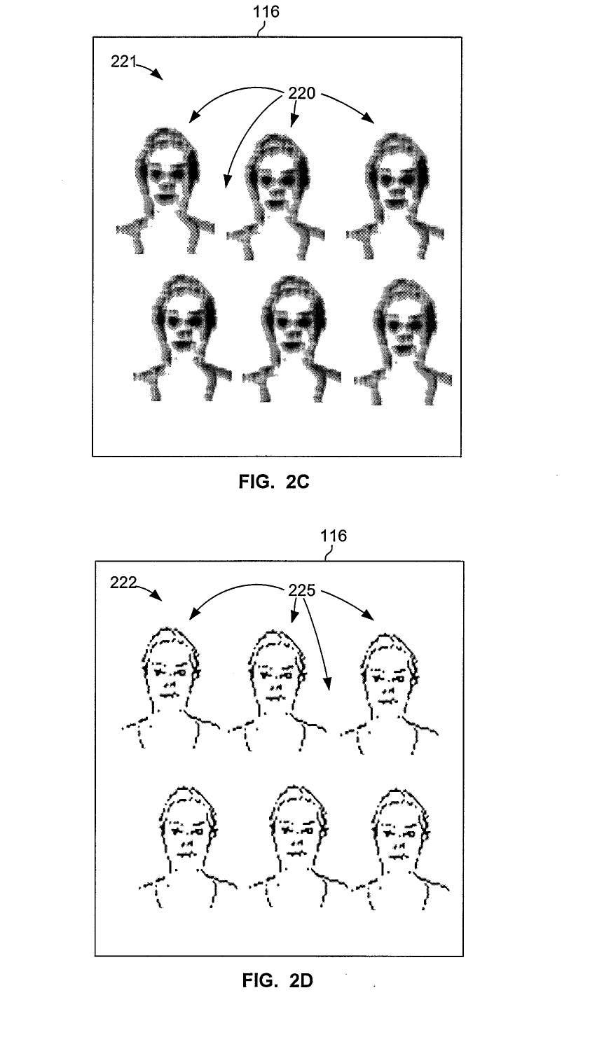

FIG. 2A is an example showing positions of eyes 202 and irises 208 in an image which includes an idealized approximate facial region (AFR) 200 of an audience member 105(*) that is looking essentially directly at the camera, i.e., within approximately 5 to 10 degrees of the optical axis of the imaging camera 106(*). In FIG. 2A, box 203, which is shown for illustrative purposes only, represents the head of a person being imaged by a camera 106. In the present example, arrow 207, which points directly toward a camera 106(*) and thus also in the direction in which the person is looking, (i.e., the direction in which the person's head 203 is facing), is essentially orthogonal to the image plane 230 of the head in which AFR 200 is shown.

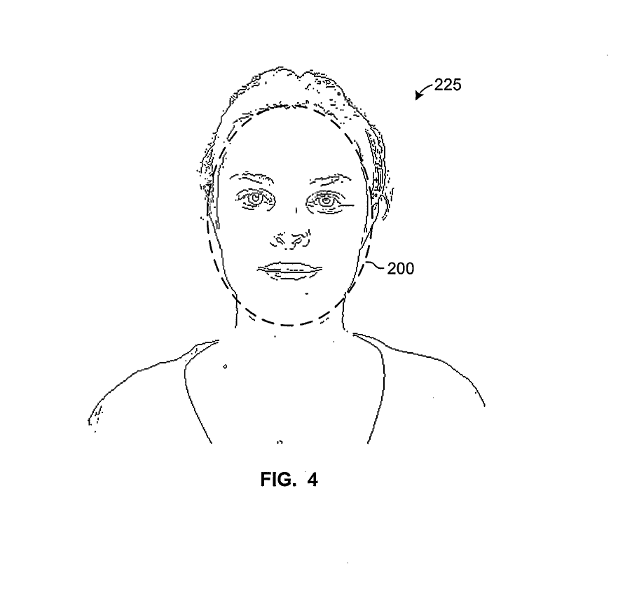

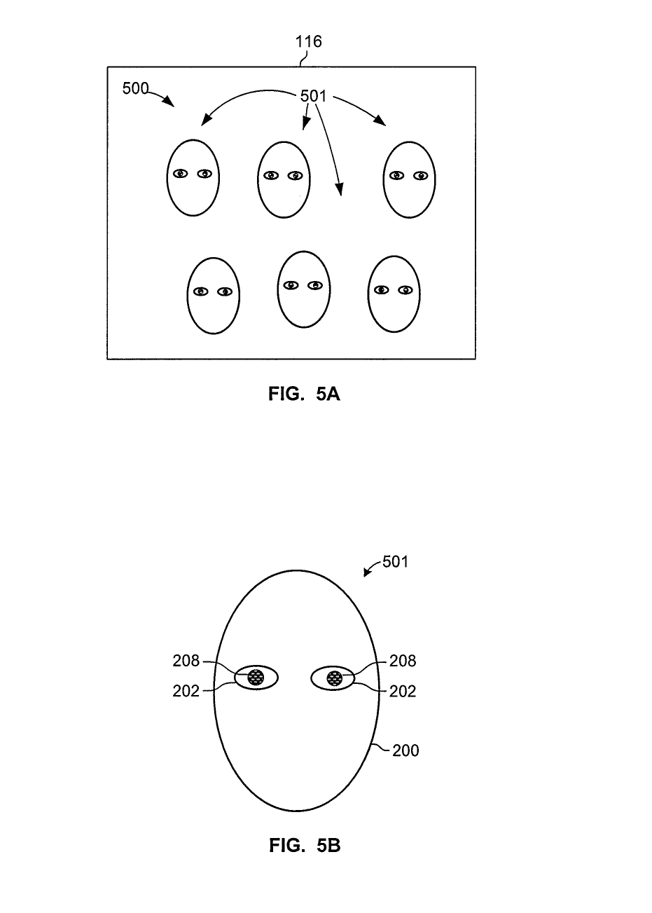

Certain relationships must exist within a region of an image frame 116 in order for the region of the image in the frame to be considered as a face 215 or AFR 200. These relationships include the spacing 204 between the center of each iris 208 and a maximum angle of eye axis rotation 205. Eye axis rotation angle 205 is the angle between the horizontal (e.g., a line level with the lecture room floor) and a line 206 drawn between the centers of each iris 208. These relationships are described in detail below with respect FIGS. 4 and 5.

FIG. 2B is an example showing positions of eyes 202 and irises 208 in an image which includes an idealized approximate facial region (AFR) 200, captured by a camera 106(*), of the face in FIG. 2A, where that face is looking away from (i.e., not directly at) the camera. As shown in FIG. 2B, the image plane 230 of the head is not orthogonal to the and thus arrow 207 is not pointing directly toward a camera 106(*). In the situation shown in FIG. 2B, each iris 208 is an ellipse with an normally vertical major axis 210, if the person's head is not tilted significantly with respect to the horizontal.

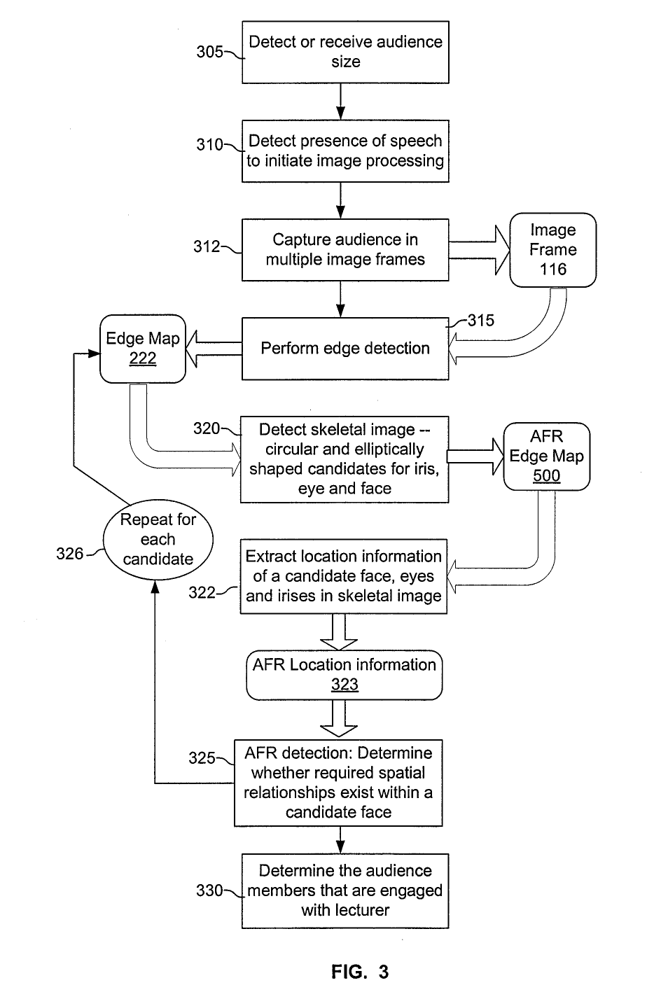

In various embodiments, the relationships shown in FIGS. 2A and 2B are employed by the present system and method in the analysis described below. More specifically, the above-described factors relating to eye and iris positions are considered by shape analysis module 112 in the AFR detection phase of the present audience participation determination, described below with respect to FIG. 3, step 325.

### Audience Engagement Detection

FIG. 3 is a flowchart showing an exemplary set of steps performed in one embodiment of the present method for determining whether audience members are engaged with a lecturer. In response to instructions from assessment module 114, video analysis module 107 invokes edge detection module 111 and shape detection module 112 to perform aspects of audience engagement determination described below.

Insofar as the present method is concerned, it is the percentage of ‘engaged’ audience members that is of primary importance; thus, the total number of audience members must be known or determined. As shown in FIG. 3, at step 305, the audience size is received via manual input from input device 120, or determined by analysis of one or more image frames 116 captured by a camera 106(*).

### Speech Detection

During a lecture, in addition to the information transmitted via displayed graphical data (e.g., on a monitor or chalkboard), information transmission primarily occurs when a lecturer is speaking. Therefore, iris shape checking need only be performed when audio is being actively generated by the lecturer.

A simple audio level-based method is used to detect speech. During system operation, the audio signal from a microphone 102, placed on or near the lecturer, is analyzed by audio module 103. An abrupt increase in the audio signal level for a sustained period indicates speech activity. Initially, a threshold for the received audio energy level is manually pre-determined to distinguish between ambient noise and speech activity from the speaker. After this audio threshold is established, its value is subsequently used to determine when to trigger audience engagement analysis. Accordingly, at step 310, image processing is initiated in response to the detection of sound, presumed to be speech, when the established audio threshold value is exceeded.

### Edge Detection

FIG. 2C is an example of an image frame 116 containing an initial image 221 including candidate images 220 of multiple audience members 105(*) in audience 104. At step 312, the audience 104, or a part thereof, is captured in a sequence of digital image frames 116, such as the exemplary image frame 116 shown in FIG. 2C. In an exemplary embodiment, one or more video cameras 106(*) are used to capture video image frames 116 of audience 104, comprising audience members 105(1)-105(N), as shown in FIG. 1A, and as explained in further detail with respect to FIGS. 6A, 6B, and 6C, described below.

At step 315, edge detection is performed in an image frame, e.g., frame 116 in FIG. 2C, as a preprocessing step for analysis of shapes, using edge detection module 111 to generate binary edge map 222 which includes a plurality of individual candidate facial images 225. FIG. 2D is an example of an edge map 222 showing multiple candidate facial images 225 after edge detection has been performed on initial image 221 in image frame 116.

Multiple edge detection methods with varying threshold parameters may be employed to locate shapes corresponding to AFRs 200, eyes 202, and irises 208. Several well-known edge detection methods that may be used in the present analysis are briefly described below.

### Sobel Operator:

The Sobel Operator method for edge detection computes the gradient of light intensities at each pixel of the image.

(a) The magnitude of the gradient gives the strength of the edge, and the direction of the gradient gives the orientation of the edge.

(b) A threshold operation is performed on the magnitude to convert the image into binary edge map. Pixels with gradient magnitude greater than a threshold parameter are assigned a value of 1; otherwise, a value of 0 is assigned.

(c) Kernels which may be used for gradient estimation by convolution include the following:

$$Sobel Gradient Estimation Kernels$$

$${F}_{x} = [ \begin{matrix}- 1 & 0 & + 1 \\ - 2 & 0 & + 2 \\ - 1 & 0 & + 1\end{matrix} ] , \\ {F}_{y} = [ \begin{matrix}- 1 & - 2 & - 1 \\ 0 & 0 & 0 \\ + 1 & + 2 & + 1\end{matrix} ]$$

### Prewitt Operator:

The only difference between a Prewitt operator and a Sobel operator is the kernel used to perform gradient estimation. Gradient Estimation Kernels which may be used with a Prewitt operator are shown below:

$$Prewitt Gradient Estimation Kernels$$

$${F}_{x} = [ \begin{matrix}- 1 & 0 & + 1 \\ - 1 & 0 & + 1 \\ - 1 & 0 & + 1\end{matrix} ] , \\ {F}_{y} = [ \begin{matrix}- 1 & - 1 & - 1 \\ 0 & 0 & 0 \\ + 1 & + 1 & + 1\end{matrix} ]$$

### Canny Method:

The Canny method for edge detection comprises the following steps:

(a) A Gaussian blurring filter is used to remove some amount of speckle noise.

(b) Both Sobel and Prewitt operators are used to obtain the gradient map of the image.

(c) Using a high threshold value for gradient magnitude, strong edge segments are extracted.

(d) Using hysteresis analysis, weak segments are extracted while setting the threshold to a low value.

FIG. 4 is a diagram showing an exemplary candidate facial image 225 obtained after edge detection.

### Shape Analysis

At step 320, binary edge map 222 is input to shape analysis module 112, which analyzes the map to generate a binary image (AFR edge map 500, described below) comprising candidate faces, eyes, and irises. When two ellipses (potentially eyes 202), each containing a circular or elliptical image (potentially an iris 208), are identified within an elliptical shape corresponding to a person's face 215, which is considered to be an approximate facial region (AFR) 200 in binary image 116. Only those circular and elliptical shapes which are in an AFR 200 are retained, in order to remove false positives.

In an exemplary embodiment, a Hough transform is employed to extract each candidate (1) iris 208 with circular shape, (2) eye outline 202 with elliptical shape, and (3) large ellipse for the face outline or AFR 200. Other curve detection or shape recognition algorithms may alternatively be employed to extract these shapes.

### Hough Transform

A Hough Transform is a well-known technique for detecting curves. This method involves transforming the pixels in an image to a parameterized curve space and selecting the most frequently occurring parameters. The present system detects circles and ellipses in the faces in edge map 222, employing, in one embodiment, a Hough transform.

An ellipse is can be described by the following equation:

$$Ellipse {Determination \\ ( \frac{x - h}{a} )}^{2} + {( \frac{y - k}{b} )}^{2} = 1 \qquad Equation 1$$

Thus an ellipse has 4 parameters. A circle is a special case of an ellipse where a=b. In step 320, each point in edge map 222 is transformed to this 4-parameter discrete space. The parameters which have the highest occurrence locally are chosen for that section of the image. The parameters thus obtained define the circles and ellipses generated in the resultant AFR edge map 500, which is input to the next step (step 322) of the present shape analysis.

FIG. 5A is a diagram showing circles and ellipses comprising candidate AFR skeletal images 501 found in an exemplary AFR edge map 500 derived from edge map 222. FIG. 5B is a diagram showing a candidate AFR image 501 comprising an exemplary detected ellipse corresponding to an AFR 200, found in edge map 222, which includes elliptical eyes 202 and irises 208.

### Approximate Face Region (AFR) Detection

At step 322, location information 323, which includes the center co-ordinates of face, eye and iris with respect to the center co-ordinates of the containing AFR 200 are extracted, using the shape analysis module 112, from AFR edge map 500 for one of the candidate facial images 225. Approximate face regions (AFRs) 200 are determined by examining AFR edge maps 500 to find combinations of two approximately circular shapes (each representing the iris in a respective observer's eyes), two approximately elliptical shapes (the observer's eyes) and one large elliptical shape (the observer's face) such that a line 206 (FIG. 2B) drawn between the centers of the pair of circular shapes or elliptical shapes is approximately perpendicular to the major axis 211 of the larger elliptical shape (i.e., AFR 200) corresponding to the face.

At step 325, location information 323 is used to determine whether the required spatial relationships exist within a candidate face in an image frame 116 in order for that region of the image in the frame to be considered as a face or approximate facial region (AFR) 200. As shown in FIG. 2B, these relationships include the spacing (distance) 204 between the center of each iris 208 relative to the height (major axis) of the ellipse 109 representing the face, and the angle of eye axis rotation 205 [an eye “plane” would need an additional parameter]. The major axis (height) of face ellipse has less variation in length compared to minor axis (width) during head rotation. Eye axis rotation angle 205 is the angle between the horizontal (e.g., a line level with the lecture room floor) and a line 206 drawn between the centers of each iris 208. In order to determine that particular pair of circles or ellipses is in fact the irises of a person, the spacing 204 between the centers of each iris 208 should in the range of 0.4-0.6 relative to length of major axis 211, and the maximum eye axis rotation angle 205 is approximately 15 degrees. Face candidates not satisfying these constraints are removed from further consideration.

### Determination of Engagement of Each Face

Using a skeletal AFR image 501, if a member of the audience is looking at the camera, and hence considered to be engaged, the member's iris is nearly (or actually) circular and elliptical otherwise. A positive detection, which indicates that a particular audience member is engaged, is defined as the detection of circular shape for one iris out of two, in a particular AFR 200. If iris ellipse minor axis and major axis have a ratio greater than 0.9, it is considered to be an essentially circular shape.

The regions around each detected eye ellipse, called initial eye region 240 (shown in FIG. 2B), are then extracted. In an exemplary embodiment, normalized cross-correlation is used to find each of these eye region candidates 240 in subsequent windows of, for example, 10 frames each. Thus, eye region candidates 240 are obtained from a predetermined number of frames, e.g., 11 continuous frames, where the time interval between successive inspected frames is preferably between approximately 50-100 milliseconds. Thus, the average engagement level is updated every 0.5-1 second for each face. Closed shapes and nearly-enclosed areas are searched for in each eye region candidate 240 to detect circular or nearly-circular irises 208 indicating an engaged face. If shapes approximating circles, and corresponding to a particular face, are detected in each eye region in more than a predetermined percentage of frames of frames within a certain interval, e.g., 5 frames within a 10 frame interval, that person is considered to be looking at the speaker, and hence engaged. Thus, by accumulating results from multiple continuous images from a video stream, the present system is made robust to momentary head movements.

Steps 320 through 325 are then repeated for each candidate face image region 225 in a given frame 116, as indicated by block 326 in FIG. 3.

In a classroom scenario, the face locations can be assumed to be fairly local and have no large displacements. Once a face is detected, it can be assumed to remain fairly constant throughout class session. In an exemplary embodiment, the center co-ordinates of the face ellipse may be used as an identifier for the face. Engagement results using circle detection in eye region candidates in subsequent frames may be stored using this identifier. This information can be used to obtain engagement level of each face through the classroom session.

### Calculate Audience Observation Percentage

At step 330, once engagement level of all faces is determined, those that are directed sufficiently toward the lecturer are tabulated to calculate the percentage of engaged audience using a standard percentage calculation:

$$Percentage Calculation \\ P = \frac{\frac{e}{2}}{A} \qquad Equation 2$$

Where P=percentage of engaged audience members, e=number of engaged eyes, and A=number of audience members

A person in an audience may turn their head and look away from the speaker for brief moments during a discourse. If decisions regarding engagement are based on those instances, erroneous results would be obtained. To take the possibility of momentary engagement or disengagement into account, multiple frames (for example,10 frames) are considered in determining whether a particular image is indicative of a person's being engaged or unengaged. A voting scheme based on the present frame and the 10 previous frames may be used to determine if a particular person is looking at the speaker at the time the present frame is captured.

Once the percentage P of audience engagement has been determined, the resultant value is stored in results area 118 in data storage 150, and may also be output to a display or other output device 140.

### Setup Examples

FIGS. 6A, 6B, and 6C are diagrams showing exemplary camera configurations for various podium and lecturer styles. There are several ways images 116 of an audience: 104 may be captured:

(a) Speaker at a lectern—If the lecturer 108 is standing at a lectern 129, then a single camera 106(1), as shown in FIG. 1, situated on or near the lectern and directed toward the audience, is sufficient to capture the images.

(b) Speaker pacing 1—If the lecturer 108 is moving about, then a camera 106(4) worn on the lecturer's head, for example, and generally directed toward the audience, may be used to capture the images, as shown in FIG. 6A. In FIGS. 6A-6C, the dashed arrows indicate the field of view of a particular camera 106(n).

(c) Speaker pacing 2—Alternatively, if the lecturer 108 is moving about, two cameras situated on the lectern can be employed, as shown in FIG. 6B, where one camera 106(1) is directed toward the lecturer and one camera 106(2) is directed toward the audience. This configuration may be used to determine when the lecturer is within a certain range of the camera and speaking, and only then would the system calculate the audience observation percentage.

(d) Circular podium or stage, lecturer in the center—If the lecturer 108 is within the center of an audience, multiple cameras 106(*) can be used to determine that the audience 104 is engaged. As shown in FIG. 6C, each camera 106(*) points toward the audience such that the camera views overlap minimally to avoid duplicate heads. Although only four cameras are shown, additional cameras may be used to improve system performance by providing better resolution and/or less spatial distortion.

### On-Line Lecture Assessment

On-line live-teaching, because of its lower cost, has become more and more prevalent. Using two-way video conferencing allows on-line live-teaching to occur. The individual on-line audience member engagement can be determined in the same way as a class-room or lecture-hall full of audience. For example, the method/system may utilize one or more cameras located on a tablet, laptop, or other electronic device used by the online member participating in the on-line live teaching. One difference is that the various video feeds to the lecturer are assessed via the summed results of individual video feeds rather than through a single feed.

### Non-Lecture Assessments

Television programming, movies, and music are presently available via devices including computer, smart phone, and tablets. Using existing video capability, one can determine the efficacy of various commercials, plot lines or special effects, giving direct measurement of the engagement level of the audience in real-time.

### Combination of Features:

Features described above as well as those claimed below may be combined in various ways without departing from the scope hereof. The following examples illustrate some various ways without departing from the scope hereof.

(A1) A computer-implemented method for determining engagement of members of an audience during a lecture given by a lecturer including: (i) capturing a frame of image data of the audience using a camera, (ii) performing edge detection on the frame of image data to generate a digital edge map of the frame of image data, (iii) detecting an approximate facial region skeletal image of a candidate in the image frame including identifying irises, eyes, and face of the candidate based upon one or more of circular and elliptical shapes within the digital edge map, (iv) extracting location information for the face, eyes, and irises in the frame of image data, and (v) classifying the candidate as an engaged member, non-engaged member, or non-member based upon spatial relationships within the location information; wherein, when an iris is essentially circular, the candidate is classified as an engaged member.

(B1) In the method described above in (A1), the method may further include receiving an indication of the number of members of the audience.

(C1) In any of the methods described above in (A1)-(B1), the method may further include repeating steps (iii) through (iv) for each candidate in the frame of image data to classify each of candidates to determine the audience members that are engaged with lecturer.

(D1) In any of the methods described above in (A1)-(C1), the method may further include detecting speech by the lecturer; wherein steps (i) through (v) are initated upon detection of speech by the lecturer.

(E1) In the method described above in (D1), the step of detecting speech by the lecturer including predetermining an audio threshold value and comparing an audio input level agains the audio threshold value to determine when the lecturer is speaking.

(F1) In any of the methods described above in (A1)-(E1), the step of capturing a frame of image data including capturing multiple frames of image data using a video camera.

(G1) In any of the methods described above in (B1)-(F1), the step of receiving an indication of the number of members of the audience including automatically determining the number of members from the audience based upon the frame of image data.

(H1) In any of the methods described above in (A1)-(G1), step (ii) including performing one or more of edge detection algorithms chosen from the group of algorithms comprising: Sobel operator algorithm, Prewitt operator algorithm, and Canny algorithm.

(I1) In any of the methods described above in (A1)-(H1), step (iii) including performing a Hough transform to extract the irises having a first circular or elliptical shape, the eyes having a second circular or elliptical shape, and the face having an third elliptical shape; wherein the second circular or elliptical shape is larger than the first circular or elliptical shape, and the third elliptical shape is larger than the second circular or elliptical shape.

(J1) In any of the methods described above in (A1)-(I1), the location information including (a) spacing between a center of each circle or ellipse representing the irises, (b) an angle of eye axis rotation based upon a line drawn between the centers of each circle or ellipse representing the irises and a line level with a floor of the lecture room, and (c) a major axis of a large ellipse representing the face.

(K1) In any of the methods described above in (A1)-(J1), the iris detected in steps (iii) and (iv) being circular in shape wherein the iris includes a minor axis and a major axis having a ratio greater than 0.9.

(L1) In any of the methods described above in (A1)-(K1), further including repeating steps (i) through (v) to analyze subsequent ones of the multiple frames of image data.

(M1) In any of the methods described above in (A1)-(L1), further including determining the percentage of engaged audience based upon a total number of members, defined as a sum of engaged and non-engaged members, and a number of engaged members.

(N1) A system for determining engagement of an audience during a lecture given by a lecturer including (i) a camera for capturing a frame of image data of the audience and storing the frame of image data within a non-transitory data storage medium, the frame of image data including a candidate representing a potential member within the audience; (ii) an edge detection module for generating a digital edge map of the frame of image data; (iii) a shape analysis module for (a) detecting an approximate facial region skeletal image candidate by identifying the irises, the eyes, and the face of the candidate based upon one or more of circular and elliptical shapes within the digital edge map, and, (b) generating location information for the face, eyes, and irises of the candidate; and, (iv) an assessment module for classifying the candidate as an engaged member, non-engaged member, or non-member based upon spatial relationships within the location information; wherein, when one of the irises is essentially circular, the candidate is classified as an engaged member.

(O1) In the system described above in (N1), the system further including an audio module for detecting speech by the lecturer, wherein the edge detection module, the shape analysis module and the assessment module are initiated based upon detection of speech by the lecturer.

(P1) In the system described above in (O1), the audio module including a predetermined audio threshold; and instructions for comparing an audio input level against the audio threshold value to determine when the lecturer is speaking.

(Q1) In any of the systems described above in (N1)-(P1), the camera capturing and storing multiple frames of image data using a video camera.

(R1) In any of the systems described above in (N1)-(Q1), the assessment module further including instructions for automatically determining the number of members from the audience based upon the frame of image data.

(S1) In any of the systems described above in (N1)-(R1), the edge detection module includes one or more edge detection algorithms chosen from the group of algorithms including: Sobel operator algorithm, Prewitt operator algorithm, and Canny algorithm.

(T1) In any of the systems described above in (S1)-(T1), the shape analysis module including a Hough transform algorithm, and, the location information including a first circular or elliptical shape of the irises, a second circular or elliptical shape of the eyes, and a third elliptical shape of the face such that the second circular or elliptical shape is larger than the first circular or elliptical shape, and the third elliptical shape is larger than the second circular or elliptical shape.

(U1) In any of the systems described above in (N1)-(T1), the location information including (a) spacing between a center of each circle or ellipse representing the irises, (b) an angle of eye axis rotation based upon a line drawn between the centers of each circle or ellipse representing the irises and a line level with a floor of the lecture room, and (c a major axis of a large ellipse representing the face.

(V1) In any of the systems described above in (N1)-(U1), wherein one of the irises is essentially circular when the iris includes a minor axis and a major axis having a ratio greater than 0.9.

(W1) In any of the systems described above in (N1)-(V1), wherein the edge detection module, the shape analysis module, and the assessment module analyze subsequent ones of the multiple frames of image data.

(X1) In any of the systems described above in (N1)-(W1), the assessment module further including instructions for determining the percentage of engaged audience based upon a total number of members, defined as a sum of the engaged and non-engaged members, and the number of engaged members.

Changes may be made in the above embodiments without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present system and method, which, as a matter of language, might be said to fall there between.

We claim:

1. A computer-implemented method for determining engagement of members of an audience during a lecture given by a lecturer comprising:
(1) receiving an indication of the number of members of the audience;
(2) capturing a frame of image data of the audience using a camera;
(3) performing edge detection on the frame of image data to generate a digital edge map of the frame of image data;
(4) detecting an approximate facial region skeletal image of a candidate in the image frame including identifying irises, eyes, and face of the candidate based upon one or more of circular and elliptical shapes within the digital edge map;
(5) extracting location information for the face, eyes, and irises in the frame of image data;
(6) classifying the candidate as an engaged member, non-engaged member, or non-member based upon spatial relationships within the location information;
wherein, when an iris is essentially circular, the candidate is classified as an engaged member; and
repeating steps (4) through (6) for each candidate in the frame of image data to classify each of candidates to determine the audience members that are engaged with lecturer.

2. The computer-implemented method for determining engagement of an audience of claim 1, further comprising:
detecting speech by the lecturer;
wherein steps (2) through (6) are initiated upon detection of speech by the lecturer.

3. The method of claim 2, wherein the step of detecting speech by the lecturer comprises:
predetermining an audio threshold value; and,
comparing an audio input level against the audio threshold value to determine when the lecturer is speaking.

4. The computer-implemented method for determining engagement of an audience of claim 1, wherein the step of capturing a frame of image data comprises capturing multiple frames of image data using a video camera.

5. The computer-implemented method for determining engagement of an audience of claim 1, wherein step (1) includes automatically determining the number of members from the audience based upon the frame of image data.

6. The computer-implemented method for determining engagement of an audience of claim 1, wherein step (3) includes performing one or more of edge detection algorithms chosen from the group of algorithms comprising: Sobel operator algorithm, Prewitt operator algorithm, and Canny algorithm.

7. The computer-implemented method for determining engagement of an audience of claim 1, wherein step (4) includes performing a Hough transform to extract the irises having a first circular or elliptical shape, the eyes having a second circular or elliptical shape, and the face having an third elliptical shape; wherein the second circular or elliptical shape is larger than the first circular or elliptical shape, and the third elliptical shape is larger than the second circular or elliptical shape.

8. The computer-implemented method for determining engagement of an audience of claim 1, wherein the location information includes (i) spacing between a center of each circle or ellipse representing the irises, (ii) an angle of eye axis rotation based upon a line drawn between the centers of each circle or ellipse representing the irises and a line level with a floor of the lecture room, and (iii) a major axis of a large ellipse representing the face.

9. The computer-implemented method for determining engagement of an audience of claim 1, wherein the iris detected in steps (4) and (5) is circular in shape where the iris includes a minor axis and a major axis having a ratio greater than 0.9.

10. The computer-implemented method for determining engagement of an audience of claim 4 further comprising repeating steps (2) through (6) to analyze subsequent ones of the multiple frames of image data.

11. The computer-implemented method for determining engagement of an audience of claim 1 further comprising determining the percentage of engaged audience based upon a total number of members, defined as a sum of engaged and non-engaged members, and a number of engaged members.

12. A system for determining engagement of an audience during a lecture given by a lecturer comprising:
a camera for capturing a frame of image data of the audience and storing the frame of image data within a non-transitory data storage medium, the frame of image data including a candidate representing a potential member within the audience;
an edge detection module for generating a digital edge map of the frame of image data;
a shape analysis module for
(i) detecting an approximate facial region skeletal image candidate by identifying the irises, the eyes, and the face of the candidate based upon one or more of circular and elliptical shapes within the digital edge map; and,
(ii) generating location information for the face, eyes, and irises of the candidate; and,
an assessment module for classifying the candidate as an engaged member, non-engaged member, or non-member based upon spatial relationships within the location information;
wherein, when one of the irises is essentially circular, the candidate is classified as an engaged member.

13. The system of claim 12, further comprising:
an audio module for detecting speech by the lecturer;
wherein the edge detection module, the shape analysis module and the assessment module are initiated based upon detection of speech by the lecturer.

14. The system of claim 13, wherein the audio module includes a predetermined audio threshold; and instructions for comparing an audio input level against the audio threshold value to determine when the lecturer is speaking.

15. The system of claim 12, wherein the camera captures and stores multiple frames of image data using a video camera.

16. The system of claim 12, wherein the assessment module further includes instructions for automatically determining the number of members from the audience based upon the frame of image data.

17. The system of claim 12, wherein the edge detection module includes one or more edge detection algorithms chosen from the group of algorithms comprising: Sobel operator algorithm, Prewitt operator algorithm, and Canny algorithm.

18. The system of claim 12, wherein:
the shape analysis module includes a Hough transform algorithm, and,
the location information includes a first circular or elliptical shape of the irises, a second circular or elliptical shape of the eyes, and a third elliptical shape of the face such that the second circular or elliptical shape is larger than the first circular or elliptical shape, and the third elliptical shape is larger than the second circular or elliptical shape.

19. The system of claim 12, wherein the location information includes (i) spacing between a center of each circle or ellipse representing the irises, (ii) an angle of eye axis rotation based upon a line drawn between the centers of each circle or ellipse representing the irises and a line level with a floor of the lecture room, and (iii) a major axis of a large ellipse representing the face.

20. The system of claim 12, wherein one of the irises is essentially circular when the iris includes a minor axis and a major axis having a ratio greater than 0.9.

21. The system of claim 15, wherein the edge detection module, the shape analysis module, and the assessment module analyze subsequent ones of the multiple frames of image data.

22. The system of claim 12, wherein the assessment module further includes instructions for determining the percentage of engaged audience based upon a total number of members, defined as a sum of the engaged and non-engaged members, and the number of engaged members.
